(19) United States
(12) Patent Application Publication
(10) Pub. No.: US 2025/0383587 A1
(43) Pub. Date: Dec. 18, 2025

(54) CAMERA MODULE

(71) Applicant: Samsung Electro-Mechanics Co., Ltd., Suwon-si (KR)

(72) Inventors: Joon JANG, Suwon-si (KR); Geon Hwi PARK, Suwon-si (KR); Soo Bin HA, Suwon-si (KR); You Jin JEONG, Suwon-si (KR); Jin Se KIM, Suwon-si (KR)

(73) Assignee: Samsung Electro-Mechanics Co., Ltd., Suwon-si (KR)

(21) Appl. No.: 19/057,700

(22) Filed: Feb. 19, 2025

(30) Foreign Application Priority Data
Jun. 17, 2024 (KR) 10-2024-0078440

(51) Int. Cl. G03B 17/12; G03B 30/00

(52) U.S. Cl. CPC G03B 17/12; G03B 30/00

(57) ABSTRACT

A camera module is provided. The camera module includes a lens module that is movably disposed inside the housing; and a case that surrounds at least a portion of the housing, wherein an opening through which light has passed is disposed in the case, and an inner surface of the opening includes an inner surface that is convex toward a center of the opening.

### CROSS-REFERENCE TO RELATED APPLICATIONS

This application claims the benefit under 35 USC § 119 (a) of Korean Patent Application No. 10-2024-0078440 filed on Jun. 17, 2024, in the Korean Intellectual Property Office, the entire disclosure of which is incorporated herein by reference for all purposes.

### BACKGROUND

### 1. Field

The following description relates to a camera module.

### 2. Description of Related Art

Camera modules may be installed in portable electronic devices including, but not limited to, smartphones. It is typically desirous that portable electronic devices have a reduced thickness. Accordingly, it is typically desirous that camera modules are also miniaturized. Separate from the demand for miniaturization of camera modules, there is also demand for an improved performance of camera modules, and accordingly, operations such as autofocusing (AF) adjustment, optical image stabilizing (OIS), and the like, are being added to the camera modules, so there is a limit to reducing the size of the camera module.

That is, despite the demand for miniaturization, camera modules it may be difficult to reduce the size of the camera module, and thus there is a limit to reducing the thickness of the portable electronic device.

To solve these problems, a camera module having a plurality of lenses disposed in a length direction or width direction, rather than a thickness direction of the portable electronic device, and a reflective member that changes a path of incident light has been proposed.

The camera module may have a different structure from typical camera modules, such as having a longer total track length (TTL) and a reflective member, and thus may have reduced image quality due to a flare phenomenon, which did not occur in typical camera modules.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module includes a housing; a lens module that is movably disposed inside the housing; and a case that surrounds at least a portion of the housing, wherein an opening through which light has passed is disposed in the case, and wherein an inner surface of the opening is convex toward a center of the opening.

The inner surface of the opening may include a first inner surface and a second inner surface, wherein the first inner surface and the second inner surface may be disposed to face each other along a first axis that passes through the center of the opening and is parallel to an optical axis, and wherein the first inner surface and the second inner surface may each comprise a surface that is convex toward the center of the opening.

The first inner surface and the second inner surface may be symmetrical with respect to a second axis, which is orthogonal to the first axis.

A first width of the opening, with respect to the first axis may be narrower than a second width of the opening, with respect to the second axis.

The first inner surface may include a first-first inner surface that is convex toward the second axis, and a first-second inner surface that is concave from the second axis, and the first-first inner surface and the first-second inner surface may be connected.

The first-second inner surface may be disposed in plural, and the plurality of first-second inner surfaces may be respectively disposed on both sides of the first-first inner surface.

A radius of curvature of the first-first inner surface may be different from a radius of curvature of the first-second inner surface.

The opening may include a third inner surface that connects the first inner surface and the second inner surface; and a fourth inner surface that connects the first inner surface and the second inner surface, and the fourth inner surface is disposed to face the third inner surface in a second axis direction, orthogonal to the first axis, wherein the third inner surface and the fourth inner surface each comprise a curved surface.

The third inner surface and the fourth inner surface may be each concave from a direction of the first axis.

The third inner surface and the fourth inner surface may be symmetrical with respect to the first axis.

A radius of curvature of the first inner surface is different from a radius of curvature of the third inner surface.

The first inner surface may include a first-first inner surface that is convex toward the second axis, and a first-second inner surface that is concave from the second axis, wherein the first-first inner surface and the first-second inner surface are connected, and wherein a radius of curvature of the first-first inner surface, a radius of curvature of the first-second inner surface, and the radius of curvature of the third inner surface are different from each other.

In a general aspect, a camera module includes a housing; a lens module that is movably disposed inside the housing; a case that surrounds at least a portion of the housing, wherein an opening through which light has passed is disposed in the case, and wherein the opening comprises an inner surface that is convex toward a first axis parallel to an optical axis.

The opening may include a first inner surface, a second inner surface that is disposed to face the first inner surface along the first axis, a third inner surface that connects the first inner surface and the second inner surface, and a fourth inner surface that is disposed to face the third inner surface, wherein the third inner surface and the fourth inner surface may each include a surface that is convex toward the first axis.

The third inner surface may include a third-first inner surface that is convex toward the first axis and a third-second inner surface that is concave from the first axis, and the third-first inner surface and the third-second inner surface may be connected.

A radius of curvature of the third-first inner surface may be different from a radius of curvature of the third-second inner surface.

Other features and aspects will be apparent from the following detailed description, the drawings, and the claims.

### BRIEF DESCRIPTION OF DRAWINGS

FIG. 1 illustrates a perspective view of an example portable electronic device having a camera module, in accordance with one or more embodiments.

FIG. 2 illustrates a schematic perspective view of an example camera module, in accordance with one or more embodiments.

FIG. 3 illustrates a schematic exploded perspective view of an example camera module, in accordance with one or more embodiments.

FIG. 4 illustrates a plan view of a lens provided in an example camera module, in accordance with one or more embodiments.

FIG. 5A, FIG. 5B, and FIG. 5C illustrate various embodiments of a first spacer, in accordance with one or more embodiments.

FIG. 6 illustrates a schematic exploded perspective view of a reflective module, in accordance with one or more embodiments.

FIG. 7, FIG. 8, FIG. 9, and FIG. 10 illustrate various embodiments of the opening of the case, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more examples may provide a camera module that prevents a flare phenomenon.

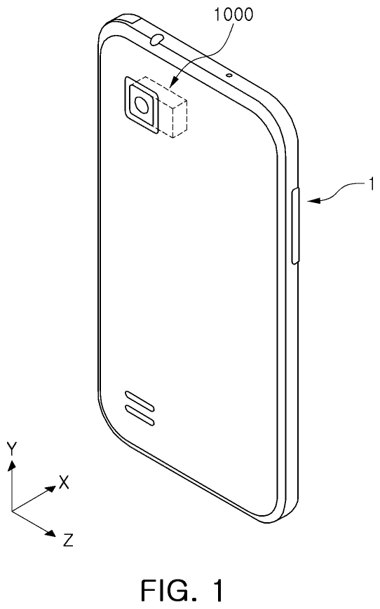

FIG. 1 illustrates a perspective view of an example portable electronic device having a camera module, in accordance with one or more embodiments.

Referring to FIG. 1, a camera module 1000, in accordance with one or more embodiments, may be installed in a portable electronic device 1. The portable electronic device 1 may be, as only examples, a portable electronic device such as a mobile communication terminal, a smartphone, a tablet personal computer (PC), or the like.

As illustrated in FIG. 1, the portable electronic device 1 has a camera module 1000 to capture an image of a subject.

In the one or more examples, the camera module 1000 includes a plurality of lenses. An optical axis (Z-axis) of the plurality of lenses may face a direction perpendicular to a thickness direction (X-axis direction), from a front surface to a rear surface of the portable electronic device, or a direction opposite thereto of the portable electronic device 1.

In an example, the optical axis (Z-axis) of the plurality of lenses provided in the camera module 1000 may be formed in a width direction or a length direction of the portable electronic device 1.

Accordingly, even if the camera module 1000 has operations such as autofocusing adjustment (AF), optical zoom (hereinafter, referred to as zoom), and optical image stabilizing (hereinafter, referred to as OIS), the thickness of the portable electronic device 1 may be prevented from increasing. Accordingly, the portable electronic device 1 may be made thinner.

The camera module 1000, in accordance with one or more embodiments, may have at least one of AF, Zoom, and OIS operations.

The camera module 1000 having the AF, Zoom, OIS operations, and the like, should have various parts, so a size of the camera module increases, as compared to a typical camera module.

As the size of the camera module 1000 increases, it may be difficult to reduce the thickness of the portable electronic device 1 in which the camera module 1000 is installed.

For example, a camera module includes a plurality of lens groups to perform a zoom operation, and when the plurality of lens groups are disposed in a thickness direction of the portable electronic device, the thickness of the portable electronic device also increases according to the number of lens groups. Accordingly, if the thickness of the portable electronic device is not increased, the number of lens groups may not be sufficiently secured, thereby weakening the Zoom performance.

Additionally, in order to implement the AF, Zoom, and OIS operations, an actuator that moves the plurality of lens groups in an optical axis direction or in a direction perpendicular to the optical axis should be installed, so when the optical axis (Z-axis) of the lens group is formed in the thickness direction of the portable electronic device, the actuator that moves the lens group should also be installed in the thickness direction of the portable electronic device. Therefore, the thickness of portable electronic devices increases.

However, since the camera module 1000, in accordance with one or more embodiments, is disposed so that the optical axes (Z-axis) of the plurality of lenses are perpendicular to the thickness direction (X-axis direction) of the portable electronic device 1, even if a camera module 1 having the AF, Zoom and OIS operations is installed, the portable electronic device 1 may be made thinner.

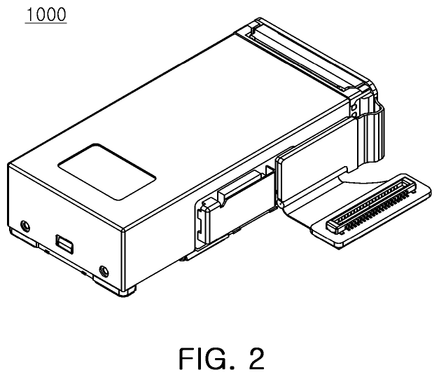

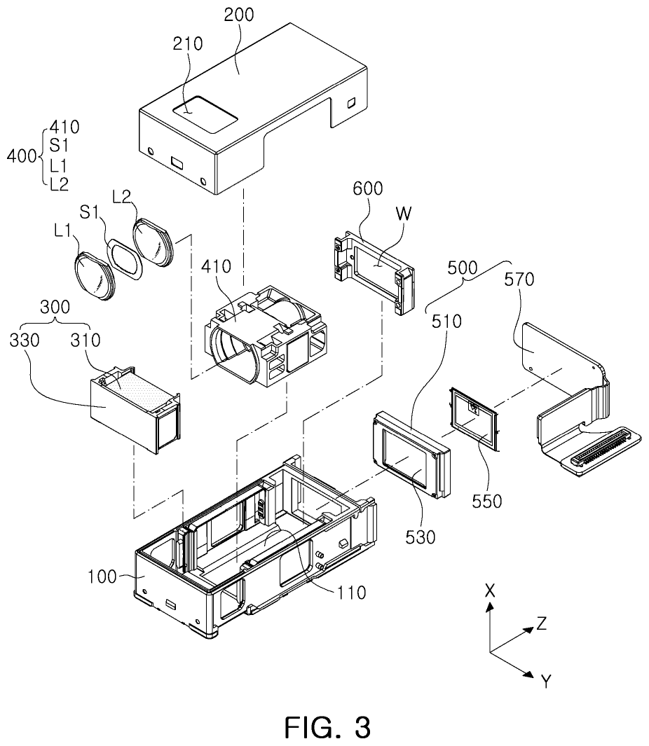

FIG. 2 illustrates a schematic perspective view of an example camera module, in accordance with one or more embodiments, and FIG. 3 illustrates a schematic exploded perspective view of an example camera module, in accordance with one or more embodiments.

Referring to FIGS. 2 and 3, the camera module 1000 includes a housing 100, a reflection module 300, a lens module 400, an image sensor module 500, and a case 200.

A reflection module 300, a lens module 400, and an image sensor module 500 are disposed from one side (for example, an object-side) to the other side (for example an image-side) inside the housing 100. The housing 100 has an internal space to accommodate the reflection module 300, the lens module 400, and the image sensor module 500. However, in an example, the image sensor module 500 may be attached to the outside of the housing 100.

FIG. 3 illustrates an example in which a reflection module 300, a lens module 400, and an image sensor module 500 are disposed inside a housing 100. However, unlike the embodiment of FIG. 3, in an example, the reflection module 300 may be disposed outside the housing 100, and in this example, one side of the housing 100 may be opened to allow light transmitted from the reflection module 300 to have passed therethrough. Additionally, in an example, the reflection module 300 disposed outside the housing 100 may be accommodated in a separate housing.

In an example, the housing 100 may have a box shape with an open upper portion.

The case 200 may be coupled to the housing 100 to cover the upper portion of the housing 100. The case 200 has an opening 210 to allow light to be incident therein. The light incident through the opening 210 of the case 200 has a travelling direction that is changed by the reflection module 300, and is incident in the lens module 400.

The reflection module 300 is configured to change a travelling direction of light. For example, the travelling direction of light incident in the interior of the housing 100 may be changed to face the lens module 400 through the reflection module 300.

The reflection module 300 includes a reflection member 310 and a holder 330 having the reflection member 310.

The reflection member 310 is configured to change the travelling direction of light. For example, the reflection member 310 may be a mirror or prism reflecting light.

The lens module 400 includes a plurality of lenses through which light, of which a travelling direction is changed by the reflection member 310, passes, and a lens barrel 410 accommodating the plurality of lenses.

For convenience of explanation, FIG. 3 illustrates a first lens (L1) disposed most adjacent to an object side among a plurality of lenses, a spacer S1 (hereinafter, referred to as a first spacer), disposed most adjacent to an object side among a plurality of spacers and disposed on the image side of the first lens (L1), and a second lens (L2) disposed on the image side of the first spacer S1. That is, the plurality of lenses may include lenses, other than the first lens (L1) and the second lens (L2), and the plurality of spacers may include spacers, other than the first spacer S1.

The image sensor module 500 includes a sensor housing 510, an infrared cut-off filter 530, an image sensor 550, and a printed circuit board 570.

An infrared cut-off filter 530 may be installed in the sensor housing 510. The infrared cut-off filter 530 may cut off light in an infrared range from among light that has passed through the lens module 400.

The printed circuit board 570 may be coupled to the sensor housing 510, and an image sensor 550 may be installed in or on the printed circuit board 570.

Light that has passed through the lens module 400 is received by the image sensor module 500 (for example, the image sensor (550)).

At least one lens among the plurality of lenses may have a non-circular planar shape. For example, the first lens (L1) may be non-circular when viewed in an optical axis direction (Z-axis direction). In an example, all of the plurality of lenses may have non-circular planar shapes.

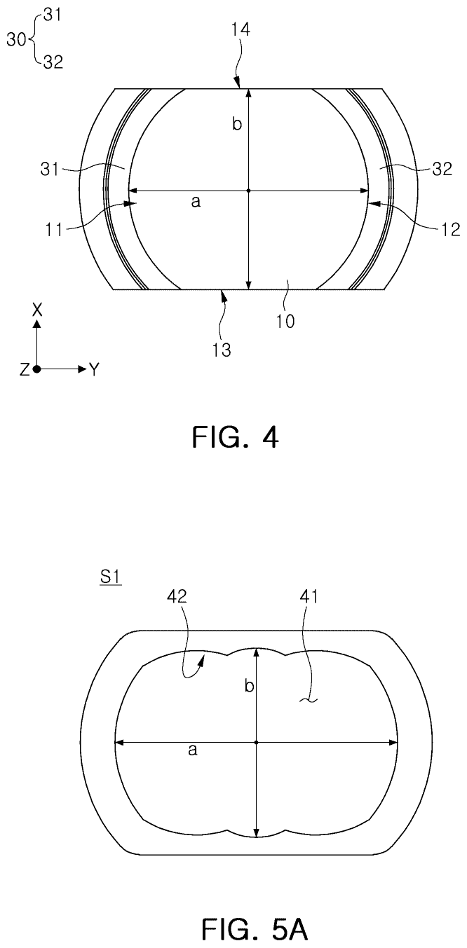

Referring to FIG. 4, in a plane perpendicular to an optical axis (Z-axis), a length (b) of the first lens (L1) in a first direction (X-axis direction) perpendicular to the optical axis (Z-axis) is shorter than a length (a) thereof in a second direction (Y-axis direction) perpendicular to both the optical axis (Z-axis) and the first direction (X-axis direction).

In an example, the first lens L1 has a major axis (a) and a minor axis (b). A line segment passing through the optical axis (Z-axis) and connecting both side surfaces of the first lens (L1) in the first direction (X-axis direction) is a minor axis, and a line segment passing through the optical axis (Z-axis) and connecting both side surfaces of the first lens (L1) in the second direction (Y-axis direction) is a major axis. The major and minor axes are perpendicular to each other, and the length of the major axis (a) is longer than the length of the minor axis (b).

The first lens (L1) includes an optical unit 10 and a flange unit 30.

The optical unit 10 may be a portion in which optical performance of the first lens (L1) is illustrated. For example, light reflected from a subject may pass through the optical unit 10 and be refracted.

The optical unit 10 may have refractive power and an aspherical shape.

The flange unit 30 may be configured to secure the first lens (L1) to another configuration, for example, a lens barrel 410 or another lens.

The flange unit 30 may extend from the optical unit 10, and may be formed integrally with the optical unit 10.

The optical unit 10 may be formed in a non-circular shape. For example, the optical unit 10 may be non-circular when viewed in the optical axis direction (Z-axis direction). Referring to FIG. 4, in a plane perpendicular to an optical axis (Z-axis), the optical unit 10 has a length in a first direction (X-axis direction) perpendicular to the optical axis (Z-axis) which is shorter than a length thereof in a second direction (Y-axis direction) perpendicular to both the optical axis (Z-axis) and the first direction (X-axis direction).

The optical unit 10 includes a first edge 11, a second edge 12, a third edge 13, and a fourth edge 14.

When viewed from the optical axis direction (Z-axis direction), the respective first edge 11 and the second edge 12 have an arc shape.

The second edge 12 is provided on an opposite side of the first edge 11. Additionally, the first edge 11 and the second edge 12 are disposed to face each other based on the optical axis (Z-axis).

The fourth edge 14 is provided on an opposite side of the third edge 13. Additionally, the third edge 13 and the fourth edge 14 are disposed to face each other with respect to the optical axis (Z-axis).

The third edge 13 and the fourth edge 14 connect the first edge 11 and the second edge 12, respectively. The third edge 13 and the fourth edge 14 are symmetrical with respect to the optical axis (Z-axis), and may be formed to be parallel to each other.

When viewed from the optical axis direction (Z-axis direction), the first edge 11 and the second edge 12 include an arc shape, and the third edge 13 and the fourth edge 14 include a generally straight shape.

The optical unit 10 has a major axis (a) and a minor axis (b). A line segment connecting the third edge 13 and the fourth edge 14 at the shortest distance while having passed through the optical axis (Z-axis) is a minor axis (b), and a line segment connecting the first edge 11 and the second edge 12 while having passed through the optical axis (Z-axis), and perpendicular to the minor axis (b) is a major axis (a). The length of the major axis (a) is longer than the length of the minor axis (b).

The flange unit 30 extends in the second direction (Y-axis direction) along a periphery of a portion of the optical portion 10. At least a portion of the flange unit 30 contacts an inner surface of the lens barrel 410.

The flange unit 30 includes a first flange unit 31 and a second flange unit 32. The first flange unit 31 extends from the first edge 11 of the optical portion 10, and the second flange unit 32 extends from the second edge 12 of the optical portion 10.

The first edge 11 of the optical portion 10 may mean a portion adjacent to the first flange unit 31, and the second edge 12 of the optical portion 10 may mean a portion adjacent to the second flange unit 32.

The third edge 13 of the optical portion 10 may mean one side surface of the optical portion 10 in which the flange unit 30 is not formed, and the fourth edge 14 of the optical portion 10 may mean the other side surface of the optical portion 10 in which the flange unit 30 is not formed.

In an example, referring to FIG. 3, the first lens (L1) is disposed so that one of the side surfaces facing the first direction (X-axis direction) faces a bottom surface 110 of the housing 100, and side surfaces thereof facing the second direction (Y-axis direction) face the inner surface of the housing 100. That is, the first lens (L1) is disposed so that the side surfaces facing the first direction (X-axis direction) face a thickness direction (X-axis direction) of the housing 100, and the side surfaces facing the second direction (Y-axis direction) face a width direction (Y-axis direction) of the housing 100.

Since the first lens (L1) is formed so that the length in the first direction (X-axis direction) is shorter than the length in the second direction (Y-axis direction), the thickness of the housing 100 may be reduced.

Referring to FIG. 3, a first spacer S1 may be disposed behind the first lens (L1). A lens may be disposed in front of the first spacer S1, and in an example, another lens may be additionally disposed in front of the first spacer S1, in addition to the first lens (L1). That is, since the first spacer S1 is disposed behind the first lens (L1), light passing through the first lens (L1) may pass through the first spacer S1.

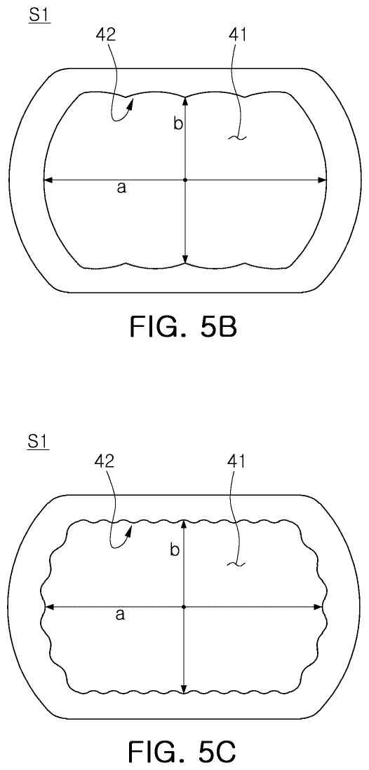

FIGS. 5A to 5C illustrate various embodiments of a first spacer, in accordance with one or more embodiments.

Referring to FIG. 5, the first spacer S1 has a major axis (a) and a minor axis (b). A plane of the first spacer S1 may have a shape similar to an oak barrel.

The first spacer S1 may have a ring structure with a center being penetrated. That is, the first spacer S1 may include a hole 41. Light having passed through the first lens (L1) may pass through the hole 41 of the first spacer S1.

An inner surface 42 of the first spacer S1 may include a curved surface. The inner surface of the first spacer S1 may be formed as a curved surface with repeated convex and concave surfaces. By implementation of the inner surface 42 of the first spacer S1 including the curved surface, it is possible to prevent flare occurring due to reflection from the inner surface 42 of the first spacer S1.

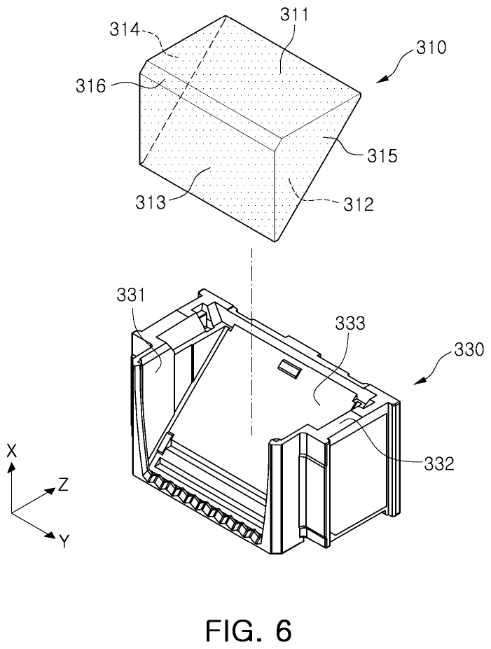

FIG. 6 is a schematic exploded perspective view of a reflection module, in accordance with one or more embodiments.

Referring to FIG. 6, the reflection module 300 includes a reflective member 310 and a holder 330 in which the reflective member 310 is disposed.

The reflective member 310 is configured to change a travelling direction of light. In the one or more examples, the reflective member 310 may be a prism, but may also be implemented as a mirror.

The reflective member 310 may be in the form of a rectangular solid or a cube divided diagonally into two halves, and includes an incident surface 311, a reflective surface 312, and an exit surface 313. The reflective member 310 includes three rectangular surfaces and two triangular surfaces. For example, the incident surface 311, the reflective surface 312, and the exit surface 313 of the reflective member 310 may be rectangular, respectively, and both side surfaces 314 and 315 of the reflective member 310 may be substantially triangular.

A corner in which the incident surface 311 and the exit surface 313 are connected is sharp, so the corner may be damaged due to impact. When the corner in which the incident surface 311 and the exit surface 313 are connected is damaged due to impact, a flare phenomenon may occur due to unintended reflection of light.

Accordingly, in order to prevent the reflective member 310 from being damaged by impact or the like, a chamfer portion 316 may be provided in a corner in which the incident surface 311 and the exit surface 313 of the reflective member 310 are connected.

For example, the chamfer portion 316 is formed to have a preset angle with respect to the incident surface 311 and the exit surface 313. An angle between the chamfer portion 316 and the incident surface 311 and an angle between the chamfer portion 316 and the exit surface 313 may be an obtuse angle.

The chamfer portion 316 may have a light-shielding layer. For example, the light-shielding layer may be formed by attaching a light-shielding film to the chamfer portion 316 or by painting the chamfer portion 316 with a light-shielding paint.

The holder 330 has a first side portion 331 and a second side portion 332 surrounding both side surfaces of the reflective member 310. The first side portion 331 is disposed to surround one side surface 314 of the reflective member 310, and the second side portion 332 is disposed to surround the other side surface 315 of the reflective member 310.

Additionally, the holder 330 has a mounting surface 333 on which the reflective member 310 is mounted. The mounting surface 333 is disposed between the first side portion 331 and the second side portion 332, and the mounting surface 333 may be configured as an inclined surface. For example, the mounting surface 333 may be an inclined surface that is inclined at 45° with respect to the optical axis (Z-axis) of the plurality of lenses. The reflective surface 312 of the reflective member 310 is coupled to the mounting surface 333 of the holder 330.

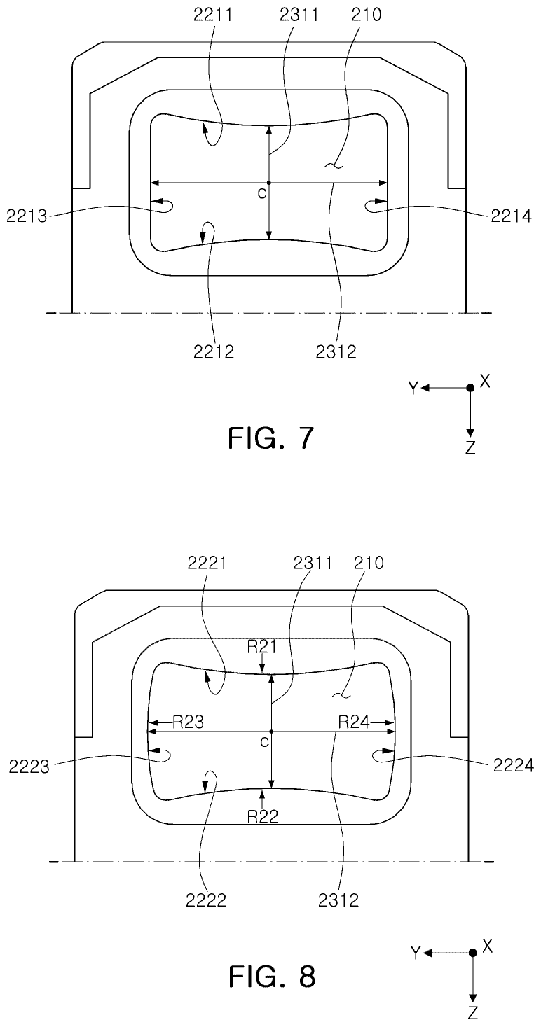

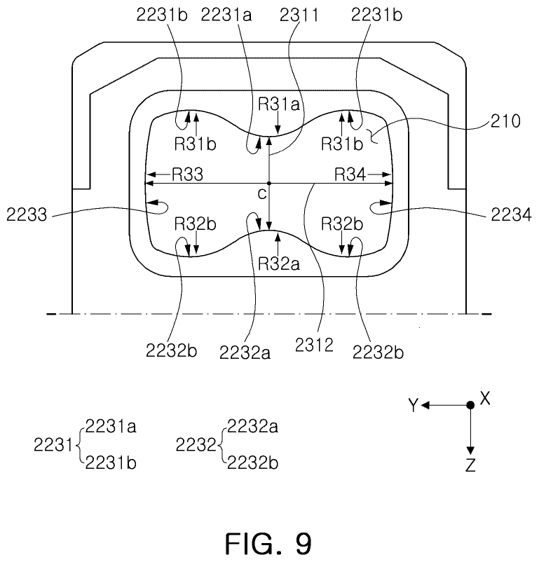

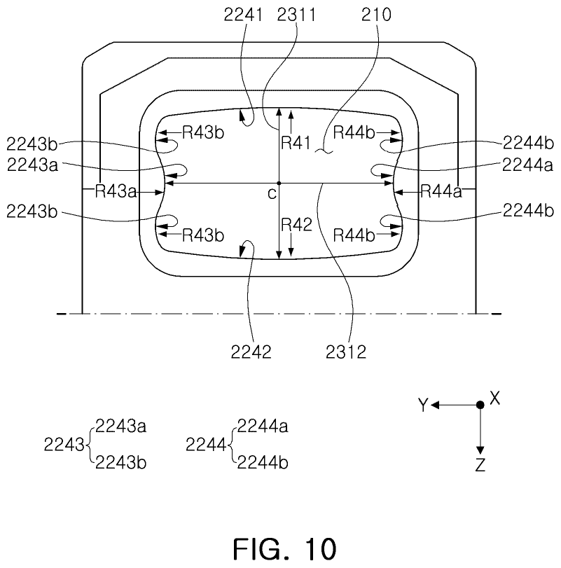

FIGS. 7 to 10 illustrate various embodiments of an opening portion of a case of the one or more embodiments.

Referring to FIGS. 7 to 10, a case 200 has an opening 210 in which light is incident.

The opening 210 may have a shape substantially corresponding to an incident surface 311 of the reflection member 310. For example, the opening 210 may be substantially similar to a square shape. Accordingly, a width of one side of the opening 210 may be narrower or wider than a width of the other side thereof.

The opening 210 may include a first width and a second width. The first width may be based on a first axis 2311 passing through a center (C) of the opening and disposed in a direction parallel to an optical axis. The second width may be based on a second axis 2312 passing through the center (C) of the opening and disposed in a Y-axis direction. The first width may be narrower than the second width. The first axis 2311 and the second axis 2312 may be orthogonal.

Based on an embodiment of FIG. 7, the opening 210 may include a first inner surface 2211, a second inner surface 2212, a third inner surface 2213, and a fourth inner surface 2214. The first inner surface 2211 and the second inner surface 2212 may have a length direction substantially parallel to the second axis 2312.

The first inner surface 2211 may be disposed to face the second inner surface 2212. The first inner surface 2211 and the second inner surface 2212 may be disposed spaced apart in a direction parallel to the first axis 2311 with the second axis 2312 interposed therebetween.

The first inner surface 2211 may include a curved surface. The first inner surface 2211 may be formed to be convex toward the center (C) of the opening. The first inner surface 2211 may be formed to be convex toward the second axis 2312.

The second inner surface 2212 may include a curved surface. The second inner surface 2212 may be formed to be convex toward the center (C) of the opening. The second inner surface 2212 may be formed to be convex toward the second axis 2312. The first inner surface 2211 and the second inner surface 2212 may have a structure which is symmetrical to each other with respect to the second axis 2312.

The third inner surface 2213 may connect the first inner surface 2211 and the second inner surface 2212. The fourth inner surface 2214 may be disposed to face the third inner surface 2213. The third inner surface 2213 and the fourth inner surface 2214 may be symmetrical with respect to the first axis 2311.

Based on an embodiment of FIG. 8, the opening 210 may include a first inner surface 2221, a second inner surface 2222, a third inner surface 2223, and a fourth inner surface 2224. The first inner surface 2221 and the second inner surface 2222 may have a longitudinal direction substantially parallel to the second axis 2312.

That is, the first inner surface 2221 may be disposed to face the second inner surface 2222. The first inner surface 2221 and the second inner surface 2222 may be disposed spaced apart in a direction parallel to the first axis 2311 with the second axis 2312 interposed therebetween.

The first inner surface 2221 may include a curved surface. The first inner surface 2221 may be formed to be convex toward the center (C) of the opening. The first inner surface 2221 may be formed to be convex toward the second axis 2312.

The second inner surface 2222 may include a curved surface. The second inner surface 2222 may be formed to be convex toward the center (C) of the opening. The second inner surface 2222 may be formed to be convex toward an optical axis passing through the opening 210. The second inner surface 2222 may be formed to be convex toward the second axis 2312. The first inner surface 2221 and the second inner surface 2222 may be symmetrical with respect to the second axis 2312.

The third inner surface 2223 may connect the first inner surface 2221 and the second inner surface 2222. The fourth inner surface 2224 may connect the first inner surface 2221 and the second inner surface 2222. The fourth inner surface 2224 may be disposed to face the third inner surface 2223. The third inner surface 2223 and the fourth inner surface 2224 have a structure which is symmetrical with respect to the first axis 2311.

The third inner surface 2223 may include a curved surface. The third inner surface 2223 may be formed to be concave with respect to the center (C) of the opening. The third inner surface 2223 may be farther away from a first axis 2311 toward the center in a direction parallel to the first axis 2311.

The fourth inner surface 2224 may include a curved surface. The fourth inner surface 2224 may be formed to be concave with respect to the center (C) of the opening. That is, the fourth inner surface 2224 may be farther away from a first axis 2311 toward the center in a direction parallel to the first axis 2311.

Since the first inner surface 2221 and the second inner surface 2222 have a symmetrical structure including a curved surface, a radius of curvature (R21) of the first inner surface 2221 and a radius of curvature (R22) of the second inner surface 2222 may be the same. Since the third inner surface 2223 and the fourth inner surface 2224 have a symmetrical structure including a curved surface, a radius of curvature (R23) of the third inner surface 2223 and a radius of curvature (R24) of the fourth inner surface 2224 may be the same.

The radius of curvature (R21) of the first inner surface 2221 may be different from the radius of curvature (R23) of the third inner surface 2223. Since a length of the first inner surface 2221 in a second axis 2312 direction is formed to be longer than a length of the third inner surface 2223 in a first axis 2311 direction, when the radius of curvature (R21) of the first inner surface 2221 is equal to or less than the radius of curvature (R23) of the third inner surface 2223, a first width of the opening 210 may become excessively narrow. Therefore, it may be preferable that the radius of curvature (R21) of the first inner surface 2221 is formed larger than the radius of curvature (R23) of the third inner surface 2223.

Based on an embodiment of FIG. 9, the opening 210 may include a first inner surface 2231, a second inner surface 2232, a third inner surface 2233, and a fourth inner surface 2234. The first inner surface 2231 and the second inner surface 2232 may have a longitudinal direction substantially parallel to the second axis 2312.

That is, the first inner surface 2231 may be disposed to face the second inner surface 2232. The first inner surface 2231 and the second inner surface 2232 may be disposed spaced apart in a direction parallel to the first axis 2311 with the second axis 2312 interposed therebetween. The first inner surface 2231 and the second inner surface 2232 may be symmetrical with respect to the second axis 2312.

The first inner surface 2231 may include a plurality of curved surfaces.

The first inner surface 2231 may include a first-first inner surface 2231a and a plurality of first-second inner surfaces 2231b. Both the first-first inner surface 2231a and the plurality of first-second inner surfaces 2231b may be formed as curved surfaces.

The first-first inner surface 2231a and the plurality of first-second inner surfaces 2231b may be connected to each other. The plurality of first-second inner surfaces 2231b may be respectively disposed on both sides of the first-first inner surface 2231a, with the first-first inner surface 2231a interposed therebetween. The first-first inner surface 2231a may be formed to be convex toward the second axis 2312. The first-second inner surface 2231b may be formed to be concave from the second axis 2312. Accordingly, the first inner surface 2231 may have convex and concave surfaces alternately disposed. A center of curvature of the first-first inner surface 2231a and a center of curvature of the first-second inner surface 2231b may be disposed on opposite sides with the first inner surface 2231 interposed therebetween. That is, an inflection point may be formed at a point at which the first-first inner surface 2231a and the first-second inner surface 2231b are connected.

The second inner surface 2232 may include a plurality of curved surfaces.

The second inner surface 2232 may include a second-first inner surface 2232a and a plurality of second-second inner surfaces 2232b. Both the first-first inner surface 2232a and the plurality of first-second inner surfaces 2232b may be formed as curved surfaces.

The second-first inner surface 2232a and the plurality of second-second inner surfaces 2232b may be connected to each other. The plurality of second-second inner surfaces 2232b may be respectively disposed on both sides of the second-first inner surface 2232a, with the second-first inner surface 2232a interposed therebetween. The second-first inner surface 2232a may be formed to be convex toward the second axis 2312. The second-second inner surface 2232b may be formed to be concave from the second axis 2312. Accordingly, the second inner surface 2232 may have convex and concave surfaces alternately disposed. A center of curvature of the second-first inner surface 2232a and a center of curvature of the second-second inner surface 2232b may be disposed on opposite sides with the second inner surface 2232 interposed therebetween. An inflection point may be formed at a point at which the second-first inner surface 2232a and the second-second inner surface 2232b are connected.

The third inner surface 2233 may connect the first inner surface 2231 and the second inner surface 2232. The fourth inner surface 2234 may connect the first inner surface 2231 and the second inner surface 2232. The fourth inner surface 2234 may be disposed to face the third inner surface 2233. The third inner surface 2233 and the fourth inner surface 2234 have a structure which is symmetrical with respect to the first axis 2311.

The third inner surface 2233 may include a curved surface. The third inner surface 2233 may be formed to be concave with respect to the center (C) of the opening. The third inner surface 2233 may be farther away from a first axis 2311 toward the center in a direction parallel to the first axis 2311.

The fourth inner surface 2234 may include a curved surface. The fourth inner surface 2234 may be formed to be concave with respect to the center (C) of the opening. The fourth inner surface 2234 may be farther away from a first axis 2311 toward the center in a direction parallel to the first axis 2311.

The first-first inner surface 2231a, the first-second inner surface 2231b, and the third inner surface 2233 may be sequentially connected. A radius of curvature (R31a) of the first-first inner surface 2231a, a radius of curvature (R31b) of the first-second inner surface 2231b, and a radius of curvature (R33) of the third inner surface 2233 may be different from each other. In this example, the radius of curvature (R33) of the third inner surface 2233 may be larger than the radius of curvature (R31a) of the first-first inner surface 2231a. Additionally, the radius of curvature (R33) of the third inner surface 2233 may be formed to be larger than the radius of curvature (R31b) of the first-second inner surface 2231b.

Based on an embodiment of FIG. 10, the opening 210 may include a first inner surface 2241, a second inner surface 2242, a third inner surface 2243, and a fourth inner surface 2244. The first inner surface 2241 and the second inner surface 2242 may have a longitudinal direction substantially parallel to a second axis.

That is, the first inner surface 2241 may be disposed to face the second inner surface 2242. The first inner surface 2241 and the second inner surface 2242 may be disposed to be spaced apart in a direction parallel to the first axis 2311 with the second axis 2312 interposed therebetween. The first inner surface 2241 and the second inner surface 2242 may be symmetrical with respect to the second axis 2312.

The first inner surface 2241 may be disposed to face the second inner surface 2242. The first inner surface 2241 and the second inner surface 2242 are symmetrical with respect to the second axis 2312.

The first inner surface 2241 may include a curved surface. The first inner surface 2241 may be formed to be concave based on the center (C) of the opening. The first inner surface 2241 may be farther away from the second axis 2312 toward the center in a direction parallel to the second axis 2312.

The second inner surface 2242 may include a curved surface. The second inner surface 2242 may be formed to be concave based on the center (C) of the opening. The second inner surface 2242 may be farther away from the second axis 2312 toward the center in a direction parallel to the second axis 2312.

The third inner surface 2243 may connect the first inner surface 2241 and the second inner surface 2242. The fourth inner surface 2244 may connect the first inner surface 2241 and the second inner surface 2242. The fourth inner surface 2244 may be disposed to face the third inner surface 2243. The third surface 2243 and the fourth surface 2244 are symmetrical with respect to the first axis 2311.

The third inner surface 2243 may include a plurality of curved surfaces.

The third inner surface 2243 may include a third-first inner surface 2243a and a plurality of third-second inner surfaces 2243b. Both the third-first inner surface 2243a and the plurality of third-second inner surfaces 2243b may be formed as curved surfaces.

The third-first inner surface 2243a and the plurality of third-second inner surfaces 2243b may be connected to each other. The plurality of third-second inner surfaces 2243b may be respectively disposed on both sides of the third-first inner surface 2243a with the third-first inner surface 2243a interposed therebetween. The third-first inner surface 2243a may be formed to be convex toward the first axis 2311. The third-second inner surface 2243b may be formed to be concave to be farther away from the first axis 2311 toward the center in a direction parallel to the first axis 2311. Accordingly, the third inner surface 2243 may have convex and concave surfaces disposed alternately.

The fourth inner surface 2244 may include a plurality of curved surfaces.

The fourth inner surface 2244 may include a fourth-first inner surface 2244a and a plurality of fourth-second inner surfaces 2244b. Both the fourth-first inner surface 2244a and the plurality of fourth-second inner surfaces 2244b may be formed as curved surfaces.

The fourth-first inner surface 2244a and the plurality of fourth-second inner surfaces 2244b may be connected to each other. The plurality of fourth-second inner surfaces 2244b may be respectively disposed on both sides of the fourth-first inner surface 2244a, with the fourth-first inner surface 2244a interposed therebetween. The fourth-first inner surface 2244a may be formed to be convex toward the first axis 2311. The fourth-second inner surface 2244b may be formed to be concave away from the first axis 2311. Accordingly, the fourth inner surface 2244 may have convex and concave surfaces alternately disposed.

The third-first inner surface 2243a, the third-second inner surface 2243b, and the first inner surface 2241 may be sequentially connected. A radius of curvature (R43a) of the third-first inner surface 2243a, a radius of curvature (R43b) of the third-second inner surface 2243b, and a radius of curvature (R41) of the first inner surface 2241 may be different from each other. In this example, the radius of curvature (R41) of the first inner surface 2241 may be larger than the radius of curvature (R43a) of the third-first inner surface 2243a. Additionally, the radius of curvature (R41) of the first inner surface 2241 may be formed to be larger than the radius of curvature (R43b) of the third-second inner surface 2243b.

When the opening of the case through which light has passed is formed as a straight structure, diffraction may occur when the light encounters the straight structure, which may cause flare.

According to the embodiments of FIGS. 7 to 10, since at least a portion of the inner surface of the opening through which light is incident is formed as a convex curved structure, the straight structure of the opening may be reduced, thereby reducing flare due to diffraction.

Light that has been incident through the opening of the case passes through the reflection module and lens module 400 and reaches an image sensor of the image sensor module 500. A plurality of lenses including a first lens (L1) disposed at the frontmost position are disposed in the lens module 400, and a first spacer S1 is disposed behind the first lens (L1). As light passes through the plurality of lenses disposed in the lens module 400, the light is focused toward an optical axis and reaches the image sensor.

When light passes through individual components of the camera module 1000, when a portion of the light encounters a straight structure disposed in the individual components of the camera module 1000, the light may be reflected from the straight structure, causing flare.

As light passes through a plurality of lenses of the lens module 400, the light is focused toward the optical axis, so the probability of encountering a straight structure disposed in individual components of the camera module 1000 decreases from an object side to an image side. That is, the closer the straight structure is disposed from the image side to the object side, the higher the probability of occurrence of flare. Therefore, a structure for reducing flare may be advantageous as the straight structure is disposed closer to the object side.

According to the one or more embodiments, by having an inner surface of the opening 210 of the case 210, disposed more adjacent to an object side than the lens module 400 and the reflection module 300, as a curved surface, flare occurring in the opening 210 of the case 200 may be reduced, and additionally, by also having an inner surface of the spacer as a curved surface, flare occurring at the inner surface of the spacer may be reduced.

As set forth above, in accordance with the one or more embodiments, a camera module may reduce a flare phenomenon.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A camera module, comprising:
a housing;
a lens module that is movably disposed inside the housing; and
a case that surrounds at least a portion of the housing,
wherein an opening through which light has passed is disposed in the case, and
wherein an inner surface of the opening is convex toward a center of the opening.

2. The camera module of claim 1, wherein the inner surface of the opening comprises a first inner surface and a second inner surface,
wherein the first inner surface and the second inner surface are disposed to face each other along a first axis that passes through the center of the opening and is parallel to an optical axis, and
wherein the first inner surface and the second inner surface each comprise a surface that is convex toward the center of the opening.

3. The camera module of claim 2, wherein the first inner surface and the second inner surface are symmetrical with respect to a second axis, which is orthogonal to the first axis.

4. The camera module of claim 3, wherein a first width of the opening, with respect to the first axis is narrower than a second width of the opening, with respect to the second axis.

5. The camera module of claim 3, wherein the first inner surface comprises a first-first inner surface that is convex toward the second axis, and a first-second inner surface that is concave from the second axis, and
wherein the first-first inner surface and the first-second inner surface are connected.

6. The camera module of claim 5, wherein the first-second inner surface is disposed in plural, and
wherein the plurality of first-second inner surfaces are respectively disposed on both sides of the first-first inner surface.

7. The camera module of claim 5, wherein a radius of curvature of the first-first inner surface is different from a radius of curvature of the first-second inner surface.

8. The camera module of claim 2, wherein the opening comprises:
a third inner surface that connects the first inner surface and the second inner surface; and
a fourth inner surface that connects the first inner surface and the second inner surface, and the fourth inner surface is disposed to face the third inner surface in a second axis direction, orthogonal to the first axis,
wherein the third inner surface and the fourth inner surface each comprise a curved surface.

9. The camera module of claim 8, wherein the third inner surface and the fourth inner surface are each concave from a direction of the first axis.

10. The camera module of claim 8, wherein the third inner surface and the fourth inner surface are symmetrical with respect to the first axis.

11. The camera module of claim 8, wherein a radius of curvature of the first inner surface is different from a radius of curvature of the third inner surface.

12. The camera module of claim 8, wherein the first inner surface comprises a first-first inner surface that is convex toward the second axis, and a first-second inner surface that is concave from the second axis,
wherein the first-first inner surface and the first-second inner surface are connected, and
wherein a radius of curvature of the first-first inner surface, a radius of curvature of the first-second inner surface, and the radius of curvature of the third inner surface are different from each other.

13. A camera module, comprising:
a housing;
a lens module that is movably disposed inside the housing;
a case that surrounds at least a portion of the housing,
wherein an opening through which light has passed is disposed in the case, and
wherein the opening comprises an inner surface that is convex toward a first axis parallel to an optical axis.

14. The camera module of claim 13, wherein the opening comprises:
a first inner surface,
a second inner surface that is disposed to face the first inner surface along the first axis,
a third inner surface that connects the first inner surface and the second inner surface, and
a fourth inner surface that is disposed to face the third inner surface,
wherein the third inner surface and the fourth inner surface each comprise a surface that is convex toward the first axis.

15. The camera module of claim 14, wherein the third inner surface comprises a third-first inner surface that is convex toward the first axis and a third-second inner surface that is concave from the first axis, and
wherein the third-first inner surface and the third-second inner surface are connected.

16. The camera module of claim 15, wherein a radius of curvature of the third-first inner surface is different from a radius of curvature of the third-second inner surface.
